(19) United States
(12) Patent Application Publication
(10) Pub. No.: US 2016/0342977 A1
(43) Pub. Date: Nov. 24, 2016

(54) DEVICE, METHOD AND SYSTEM FOR VIRTUAL ASSET TRANSACTIONS

(71) Applicant: Vennd.io Pty Ltd, St Leonards (AU)

(72) Inventor: Jeremy Lam, Queensland (AU)

(21) Appl. No.: 15/143,995

(22) Filed: May 2, 2016

(30) Foreign Application Priority Data
May 20, 2015 (AU) 2015901851

(51) Int. Cl. G06Q 20/38; H04L 9/06; H04L 9/08; G06F 17/30; G06Q 20/40

(52) U.S. Cl. CPC G06Q 20/3829; G06F 17/30377; G06F 17/30958; G06Q 20/401; H04L 9/0861; H04L 9/0643

(57) ABSTRACT

A method and system for digital currency transactions and, more specifically, a method and system for cryptocurrency transactions across ledgers or blockchains.

CROSS-REFERENCE TO RELATED APPLICATION(S)

This application claims foreign priority to Australian Provisional Appl. No. AU2015901851, filed on May 20, 2015, the disclosure of which is incorporated herein by reference in its entirety.

### TECHNICAL FIELD

The present invention relates to a method and system for digital currency transactions. More particularly, the present invention relates to cryptocurrency transactions across ledgers or blockchains.

### BACKGROUND

Virtual currencies or cryptocurrencies such as Bitcoin™ (BTC) may be traded through peer-to-peer (P2P) mediums without the need for an intermediary. The transactions are generally verified by network nodes and recorded in a public leger called a blockchain. However, a blockchain may be accessed by an entity without having any virtual currency or assets on a blockchain. Further a blockchain can be accessed by an entity who is not a miner. The blockchain can use a digital currency unit or cryptocurrency, known cryptocurrencies include; Auroracoin™, Bitcoin™, BlackCoin™, Coinye™, Dogecoin™, Litecoin™, Mastercoin™, MazaCoin™, Monero™, Namecoin™, Nxt™, Peercoin™, PotCoin™, Primecoin™, Ripple™, Titcoin™, Zerocoin™.

Transactions recorded in the ledger are commonly in form of “payer X sends Y BTC to payee Z”, with the virtual currencies being transferred between digital wallets when holds a user's virtual currency. The network nodes may then validate the transactions, add them to their copy of the ledger and then broadcast these new ledger additions to other network nodes. A blockchain is a distributed database which may independently verify the ownership of a virtual currency. A new group of transactions may create a new block which is then added to the blockchain and published to the network nodes. A blockchain is the only location where virtual currencies exist in the form of unspent outputs of transactions.

The ownership of a virtual currency generally implies that a user can spend the virtual currency which is associated with a specific address. To spend, exchange or conduct a transaction a payer must digitally sign the transaction using a private key. Without a private key, the virtual currency cannot be signed and therefore no transaction may take place.

However, the hash algorithm for these currencies may vary or may not have the same number of blockchain intervals. For example, Bitcoin™ operates with a SHA-256 hash algorithm which may produce 32-bit words (solutions). The hash-based proof-of-work algorithm employed by SHA-256 is a CPU-bound function. However, other virtual currencies, such as CryptoNote™ employs a CryptoNight hash algorithm which is a memory-bound function rather than a CPU-bound function. As such, each currency may have different inner algorithms and may also produce a different blockchain size, up to 512-bit words. Other hash algorithms are also used for other virtual currencies.

Additionally, timestamping methods for virtual currencies may be either proof-of-work schemes or proof-of-stake and proof-of-work combines schemes. The most widely used proof-of-work schemes are based on the SHA-256 hash algorithm, which was introduced by Bitcoin™, and Scrypt™, which is used by currencies such as Litecoin™. The proof-of-stake scheme is a method of securing a cryptocurrency network while also achieving distributed consensus through requesting users to show ownership of a certain amount of currency based on the proof. In contrast, proof-of-work systems run more complex hashing algorithms to validate electronic transactions. However, the scheme used for each virtual currency is largely code dependent on the coin, and therefore there is no standard form of timestamping.

While it is known to convert or transact one virtual currency to another format, such as another virtual currency, these conversions are not statefully stored. Statefully stored data may be suitable to be audited or otherwise reviewed.

In view of the stark differences between different virtual currencies there are a number of significant problems when forming transactions between different currencies and making transactions between blockchains.

Additionally, current software is unable to perform dynamic pricing calculations of virtual currencies and cannot effectively work with more than two blockchains simultaneously. As such, it may be desirable to perform mapping and/or translation of destination addresses to perform actions across more than one blockchain. It may also be desirable to coordinate between blockchains of different intervals.

Any discussion of the prior art throughout the specification should in no way be considered as an admission that such prior art is widely known or forms part of common general knowledge in the field.

### SUMMARY

### Problems to be Solved

The present invention may provide a system for perform mapping and translation of destination addresses between two or more virtual currencies.

The system of the present invention may provide a means for associating multiple asset accounts, either virtual or tangible, to a single account or a single private key.

The system of the present invention may provide an improved method or system for the transaction of virtual currencies.

The system of the present invention may provide a system for initiating at least one transaction on multiple blockchains simultaneously.

The system of the present invention may provide an improved system for dynamically pricing or assigning a value to one or more virtual currencies.

The system of the present invention may coordinate between blockchains of different blockchain intervals.

The system of the present invention may provide an improved exchange method for virtual currencies and/or virtual assets.

While the above problems to be solved are directed towards a method or system, it will be appreciated that the present invention may be one of a system, a method, a device or a process.

It is an object of the present invention to overcome or ameliorate at least one of the disadvantages of the prior art, or to provide a useful alternative.

### Means for Solving the Problem

A first aspect of the present invention may relate to a system for performing an action on a blockchain. The system may comprise a first address with an associated first private key for a first blockchain; a second address with a second key for a second blockchain; and wherein the first private key and second private key may be hashed such that a hierarchy key may be generated which may be adapted to authorise at least one action associated with at least one of the first blockchain and the second blockchain.

The system may also comprise at least one of the first and second keys may be a private key. At least one rule may be associated with one of the first and the second addresses. The at least one rule may be adapted to trigger at least one action. The hierarchy key may authorise the trade of a virtual asset. At least one address associated with the system may be a multisig address. The system may be adapted to parse a block associated with a blockchain. When an action is performed by the system a timestamp may be associated with the action. The system may be adapted to store at least one data set associated with an action. More than two blockchains may be associated with the system.

In another aspect of the present invention there may be provided a system for adapted for use with a virtual asset associated with a blockchain, wherein the system may parse at least one block associated with a blockchain and store the at least one parsed block; associate at least one user account with the at least one stored parsed block; assign a predetermined number of rules to at least one address; and when at least one of the predetermined number of rules assigned to the at least one address is triggered, an action may be performed by the system.

An action performed by the system may be a transaction. A timestamp may be associated with at least one action performed. A virtual asset may be at least one of a virtual currency, a fiat currency, a commodity, a product, a share, a stock, an object, or any other tangible asset. At least one data set associated with a parsed block may be stored on a computer readable medium. A check for a new block on at least one blockchain may be performed at a predetermined interval. More than one action may be triggered simultaneously. At least two blockchain addresses are associated with the system, such that more than one action may be performed. A hierarchy key may be associated with the at least one user account such that a hierarchy key may be used to perform actions on more than one address. The at least one user of the system may assign at least one rule to at least one account. An address comprises at least one private key which may be associated with a public key.

In the context of the present invention, the words “comprise”, “comprising” and the like are to be construed in their inclusive, as opposed to their exclusive, sense, that is in the sense of “including, but not limited to”.

The invention is to be interpreted with reference to the at least one of the technical problems described or affiliated with the background art. The present aims to solve or ameliorate at least one of the technical problems and this may result in one or more advantageous effects as defined by this specification and described in detail with reference to the preferred embodiments of the present invention.

### BRIEF DESCRIPTION OF THE FIGURES

FIG. 1 illustrates a flowchart of an example of a process for parsing a block in accordance with one embodiment of the present invention.

FIG. 2 illustrates at least some data sets of a block which has been added to a blockchain which may be used with at least one embodiment of the present invention.

FIG. 3 illustrates a flowchart for applying a rule to trigger an event or action on a blockchain.

### DETAILED DESCRIPTION

Glossary:

Address: A virtual currency address is used to receive and send transactions on the virtual currency network. It may contain a string of alphanumeric characters, but can also be represented as a scannable QR code or any other computer readable medium. A virtual currency address may also be the public key in the pair of keys used by virtual currency holders to digitally sign transactions (see Public key).

Altcoin: The collective name for virtual currencies or cryptocurrencies offered as alternatives to Bitcoin. Litecoin, Feathercoin and PPcoin are examples of altcoins.

AML: Anti-Money Laundering techniques are used to stop people converting illegally obtained funds, to appear as though they have been earned legally. AML mechanisms can be legal or technical in nature. Regulators frequently apply AML techniques to virtual currency exchanges.

ASIC: An Application Specific Integrated Circuit is a silicon chip specifically designed to do a single task. In the case of bitcoin, they are designed to process SHA-256 hashing problems to mine blocks.

Bitcoin: a type of digital currency in which encryption techniques are used to regulate the generation of units of currency and verify the transfer of funds, operating independently of a central bank. Throughout this specification is will be appreciated that the a virtual currency or a virtual asset may include a Bitcoin (BTC).

Bitcoin ATM: A bitcoin ATM is a physical machine that allows a customer to buy bitcoin with cash. There are many manufacturers, some of which enable users to sell bitcoin for cash. They are also sometimes called ‘BTMs’ or ‘Bitcoin AVMS’.

Bitcoin Market Potential Index (BMPI): The Bitcoin Market Potential Index (BMPI) uses a data set to rank the potential utility of bitcoin across 177 countries.

Bitcoin Price Index (BPI): The CoinDesk Bitcoin Price Index represents an average of bitcoin prices across leading global exchanges that meet criteria specified by the BPI.

Blockchain: The full list of blocks that have been mined since the beginning of the cryptocurrency. The blockchain is designed so that each block contains a hash drawing on the blocks that came before it.

Block reward: The reward given to a miner which has successfully hashed a transaction block. This can be a mixture of coins and transaction fees, depending on the cryptocurrency, and whether all of the coins have already been successfully mined.

Client: A software program running on a desktop or laptop computer, or mobile device. It connects to the bitcoin network and forwards transactions. It may also include a bitcoin wallet. Also see node.

Confirmation: The act of hashing a bitcoin transaction successfully into a transaction block, and proving its validity. A single confirmation will take around 10 minutes, which is the average length of time for a transaction block to be hashed. However, some more sensitive or larger transactions may require multiple confirmations, meaning that more blocks must be hashed and added to the blockchain after the transaction block has been hashed.

Colored coins: A proposed add-on function for bitcoin that would enable bitcoin users to give them additional attributes. These attributes could be user-defined, enabling you to mark a virtual currency as a share of stock, or a physical asset. This would enable virtual currencies to be traded as tokens for other property.

Coinbase: Another name for the input used in a virtual currency generation transaction. When a virtual currency is mined, it doesn't come from another virtual currency user, but is generated as a reward for the miner. That reward is recorded as a transaction, but instead of another user's bitcoin address, some arbitrary data is used as the input.

Cryptocurrency: A form of currency based on mathematics alone. Instead of fiat currency, which is printed, cryptocurrency is produced by solving mathematical problems based on cryptography. Also see virtual currency.

Cryptography: The use of mathematics to create codes and ciphers that can be used to conceal information. Used as the basis for the mathematical problems used to verify and secure virtual currency transactions.

Difficulty: This number determines how difficult it is to hash a new block. It is related to the maximum allowed number in a given numerical portion of a transaction block's hash. The lower the number, the more difficult it is to produce a hash value that fits it. Difficulty varies based on the amount of computing power used by miners on the bitcoin network. If large numbers of miners leave a network, the difficulty would decrease.

Double spending: The act of spending a virtual currency twice. It happens when someone makes a transaction using a virtual currency, and then makes a second purchase from someone else, using the same virtual currency coins. They then convince the rest of the network to confirm only one of the transactions by hashing it in a block.

Dust transaction: A transaction for an extremely small amount of bitcoins, which offers little financial value, but takes up space in the blockchain. The bitcoin developer team has taken efforts to eliminate dust transactions by increasing the minimum transaction amount that will be relayed by the network.

ECDSA: The Elliptic Curve Digital Signature Algorithm is the lightweight cryptographic algorithm used to sign transactions in the Bitcoin protocol.

Escrow: The act of holding funds or assets in a third-party account to protect them during an asynchronous transaction.

Exchange: A central resource for exchanging different forms of money and other assets. Bitcoin exchanges are typically used to exchange the cryptocurrency for other, typically fiat, currencies.

Fiat currency: A currency declared by a government to be legal tender which is not backed by a physical commodity. The value of fiat money is derived from the relationship between supply and demand rather than the value of the material that the money is made.

Fork: The creation of an alternative ongoing version of the blockchain. This is usually created due to one set of miners hashing a different set of transaction blocks from another. It can be caused maliciously, by a group of miners gaining too much control over the network, accidentally, due to a system error, or intentionally, when a core development team decides to introduce substantial new features into a new version of a client. A fork is successful if it becomes the longest version of the blockchain, as defined by difficulty, whereby the fork then is adopted as the blockchain.

Genesis block: The first block in the blockchain to be created.

Hash: A mathematical process that takes a variable amount of data and produces a shorter, fixed-length output.

HashMap: a hash table (hash map) is a data structure used to implement an associative array, a structure that can map keys to values. A hash table uses a hash function to compute an index into an array of buckets or slots, from which the correct value can be found. Using a hash map decreases the chance of a collision occurring when looking up a value. In this specification a HashMap may also be referred to as a HashSet.

Input: The part of a bitcoin transaction denoting where the bitcoin payment has come from. Typically, this will be a virtual currency address, unless the transaction is a generation transaction, meaning that the bitcoin has been freshly mined (also see coinbase).

KYC: Know Your Client/Customer rules force financial institutions to vet the people they are doing business with, ensuring that they are legitimate.

Last block: This is the newest block to be added to the blockchain, and is the furthest away from the genesis block in the blockchain.

Microtransaction: Paying a tiny amount for an asset or service, primarily online. Micro-transactions are difficult to perform under conventional payment systems, because of the heavy commissions involved.

Mining: The act of generating new virtual currency by solving cryptographic problems using computing hardware.

Mixing service: A service that mixes your virtual currency with someone else's, sending you back bitcoins with different inputs and outputs from the ones that you sent to it. A mixing service (also known as a tumbler) preserves your privacy because as it stops people tracing a particular virtual currency to you.

Multisig: Multi-signature addresses allow multiple persons to partially seed an address with a public key. This requires multiple persons to confirm a transaction which increases the safety of a transaction and reduces the potential of virtual currency theft.

Namecoin: An altcoin designed to provide an alternative to the traditional domain name system (DNS).

Node: A computer connected to the bitcoin network using a client that relays transactions to others (see client).

Nonce: A random string of data used as an input when hashing a transaction block. A nonce is used to try and produce a digest that fits the numerical parameters set by the bitcoin difficulty. A different nonce will be used with each hashing attempt, meaning that billions of nonces are generated when attempting to hash each transaction block.

Orphan block: A block which is not a part of the valid blockchain, but which was instead part of a fork that was discarded.

Output: The destination address for a bitcoin transaction. There can be multiple outputs for a single transaction.

P2P: Peer-to-peer. Decentralized interactions that happen between at least two parties in a highly interconnected network. An alternative system to a ‘hub-and-spoke’ arrangement, in which all participants in a transaction deal with each other through a single mediation point.

Paper wallet: A printed sheet containing one or more public bitcoin addresses and their corresponding private keys. Used to more securely store a virtual currency private key.

Parse block: parsing a block may split a sequence of characters or values into smaller parts. This may be used for recognising characters or values which appear in a specific order. A parse block may also be assigned predetermined attributes.

Previous block: the block number one above a block. For example, if the block number of a block is denoted by N, then the previous block number is (N−1).

Private key: An alphanumeric string kept secret by the user, and designed to sign a digital communication (such as a transaction) when hashed with a public key. In the case of a virtual currency, this string is a private key designed to work with a public key.

Proof of stake (proof-of-stake): An alternative to proof of work, in which your existing stake in a currency (the amount of that currency that you hold) is used to calculate the amount of that currency that you can mine.

Proof of work (proof-of-work): A system that ties mining capability to computational power. Blocks must be hashed, which is in itself an easy computational process, but an additional variable is added to the hashing process to make it more difficult. When a block is successfully hashed, the hashing must have taken some time and computational effort. Thus, a hashed block is considered proof of work.

Public key: An alphanumeric string which is publicly known, and which is hashed with another, privately held string to sign a digital communication. Most virtual currencies use the public key as a virtual currency address.

Satoshi: The smallest subdivision of a bitcoin currently available (0.00000001 BTC).

Scrypt: An alternative proof of work system to SHA-256, designed to be particularly friendly to CPU and GPU miners, while offering little advantage to ASIC miners.

Signature: A digital digest produced by hashing private and public keys together to prove that a bitcoin transaction came from a particular address.

SHA: a secure hash algorithm which is a type of cryptographic hash function. The output sizes for a SHA function commonly range between 128 bits to 512 bits.

SHA-256: A secure hash algorithm which may provide a cryptographic hash function. SHA-256 may commonly be used for proof-of-work for blockchains, although not all block chains use SHA-256 for proofs.

SPV: Simplified Payment Verification. A feature of at least some virtual currency protocols that enables nodes to verify payments without downloading the full blockchain. Instead, they need only download block headers.

Transaction block: A collection of transactions on a virtual currency network, gathered into a block that can then be hashed and added to the blockchain.

Vanity address: A virtual currency address with a desirable pattern, such as a name.

Virgin coin: A virtual currency which is a reward for mining a block. These have not yet been spent anywhere.

Virtual Asset: A value which is a representation of currency or other tangible asset in some environment or situation. A virtual asset may include at least one of a currency, a virtual currency, a virtual good, a virtual service, a property, a stock, a share, a good, a service, or any other economic resource which may be used in a real or virtual environment. Throughout this specification, a virtual asset may also be referred to as a virtual currency without imparting any limitations.

Virtual Currency: A form of currency that is a currency that is an unregulated, digital currency, which is issued and usually controlled by its developers, and used and accepted among members of a specific virtual community. In this specification a virtual currency may be similar to or the same as a cryptocurrency or a virtual asset.

Wallet: A method of storing a virtual currency for later use. A wallet holds the private keys associated with bitcoin addresses in a non-physical form such as on a computer readable storage device. The blockchain is the record of the bitcoin amounts associated with those addresses.

Wire transfer: Electronically transferring money from one person to another. Commonly used to send and retrieve fiat currency from bitcoin exchanges.

Preferred embodiments of the invention will now be described with reference to the accompanying drawings and non-limiting examples.

In at least one embodiment, the system of the present invention may be used to perform actions across multiple blockchains simultaneously or within a relatively short period of time, such as a matter of minutes. The system may be adapted to have a single private key or a hierarchy key which controls at least one private key below it.

A hierarchy key may be generated from a hash or other derivative of at least one private key. The hierarchy key is preferably encrypted or hashed to improve the security of at least one private key. The hierarchy key may also be associated with other financial or asset accounts, such as a bank account or a stock portfolio. This may allow the system to perform multiple transactions, actions or communications between multiple blockchains, accounts, addresses, portfolios or other private or trust asset accounts. Preferably, the system of the present invention is adapted to be used with at least one virtual currency transaction.

A virtual currency transaction, such as a bitcoin (BTC) transaction, may require approximately five entities to perform the transaction. The first entity may be a virtual currency sender initiating the transaction on the network; the second entity may be a virtual currency receiver who accepts the same virtual currency; the third entity may be virtual currency miners that act as transaction verifiers and processors by completing blocks, sometimes for a nominal fee; the fourth entity may be the core virtual currency development team, which monitor and update the virtual currency codebase throughout the life of an active blockchain; and the fifth entity may be a virtual currency exchange, which may facilitate conversion of one virtual currency to other virtual currencies, regulated currency, or other tangible asset, such as a bond or stock, and vice versa.

It will be appreciated that not all entities may be required to complete a transaction or be involved with a transaction. In one example, a transaction may only include a currency sender and a destination for the currency to be sent. It will further be appreciated that a single user may assume one or more of the entity roles, for example, the currency sender and currency receiver may be the same person or entity.

The virtual currency sender may be identified by a public key which may be visible to other users of the system. A currency receiver may also be identifiable via a public key. Each public key is preferably unique and used as an account address which may be associated with a user of the system.

A virtual currency, such as Bitcoin™, is created by a series of blocks which for a blockchain. Generally, a commonly used process for mining a virtual currency, is:
Step 1: At least one new transaction is broadcast to at least one node or miner node;
Step 2: Each node may collect at least one new transaction and store the at least one new transaction on a ledger or a block;
Step 3: Each node attempts to solve a proof-of-work its block;
Step 4: When at least one node successfully finds a proof-of-work to a challenge the node broadcasts the block to all nodes mining the blockchain;
Step 5: Nodes accept the new block only if all transactions in it are valid and are not already spent;
Step 6: Nodes may express their acceptance of the block by working on creating the next block in the chain, using the hash of the accepted block as the previous hash for the new block.

This process effectively encourages each node to work on extending the longest chain, or the node will have the potential risk that their work on new blocks for the blockchain be invalid. In the event that two nodes broadcast new block simultaneously, the nodes generally accept the first new block to be broadcast, or accept the block with the largest proof-of-work. However, if a number of nodes receive the first new block first and the remaining nodes receive the second new block first, the nodes will work on the first new block they received, and store the other respective new block or the fork block in case it becomes longer. Once the next proof-of-work is found for the first or second new block the nodes will generally switch to the blockchain with the longer proof-of-work.

New transactions are typically broadcast to the all nodes, however not all nodes receive each new transaction. Most new transactions with an associated transaction fee may be added to a new block generally within the time it takes for one to three blocks to be added to the blockchain with block broadcasts preferably being tolerant of dropped messages. Therefore, in the event that a node does not receive the newest block, it will request the block when it receives the next block and realises it has missed a block. Preferably, the system of the present invention is adapted to be used after a predetermined number of blocks have been added to the blockchain. For example, the system of the present invention may be adapted to perform a transaction after a new block has been added.

A single block in a blockchain may contain a relatively large amount of data which is not visible without computing a number of cryptographic algorithms which are associated with the block. A block hash of a block may include a hash of the previous block in the blockchain and may be used to verify the block. A block hash may be generally computed by taking the hash, preferably a SHA-256 hash, of the versionNumber and subsequently taking the hash, preferably a SHA-256 hash, of a 32 byte hash previously computed. The previously computed hash may be around 256 bits in length. After the double hash value is computed, the double hash may be stored by the system or otherwise computed each time the system accesses a block. A stored hash of a ‘previous block’ may refer to this computed double hash value. It will be appreciated that a previous block refers to the block above in the blockchain. For example, if the last block is represented on a blockchain by block number (N), the previous block will be block number (N−1).

In at least one embodiment, the blockchain is preferably downloaded or extracted from a public location which records a copy of the verified blockchain. For example a bitcoin-QT client may be used to extract a blockchain and store blockchain data. It will be appreciated that any reference to storing data may also include statefully storing at least one data set. Preferably, the blockchain does not contain any orphaned blocks, forked blocks, forked blockchains, gaps in the blockchain or any other undesirable anomalies which do not form part of the longest blockchain.

However, after a blockchain has been downloaded or extracted the blockchain may be continuously updated which may result in orphan blocks, gaps, forked blocks or forked blockchains being recorded by the system. Optionally, all blocks along the blockchain, including orphaned blocks, forked blocks, forked blockchains or any other block not on the longest blockchain may be stored by the system. If these additional blocks (not on the longest blockchain) are stored by the system the system may be adapted to take these additional blocks into account or exclude these blocks when assessing the blockchain.

All transactions for a virtual currency, such as BitcoinTM, may be stored on a virtual ledger or blockchain. The transaction records are hashed by a hashing algorithm such that they may provide verification for a future transaction for a virtual currency. All proposed transactions are added to a new ledger or potential new block which is mined by a node, an individual miner or a group of miners. If a miner is successful in providing a proof-of-work for the last block on the blockchain, the miners may then add the new ledger page or new block to the blockchain. All nodes are then notified of the addition of a new block and new transactions may be accepted to form a next block on the blockchain.

Additionally, the proof-of-work required to solve the most recently added block, which may also be referred to as the last block, on the blockchain, may vary depending on the average time is takes for a predetermined number of blocks to be solved. For example, if miners are able to solve 2016 (two thousand and sixteen) blocks within a period of two weeks, the difficulty may remain the same. However, if the 2016 (two thousand and sixteen) blocks take longer than a period of two weeks to solve, the difficulty may be reduced, or vice versa.

Some virtual currencies may use two consecutive SHA-256 hashes to verify transactions. For example, the hash RIPEMD-160 (RACE Integrity Primitives Evaluation Message Digest) may be used after a SHA-256 hash for virtual currency digital signatures or “addresses”. The virtual currency address ,may be the hash of an ECDSA public-key which may be computed using the following method for example:

Key hash=Version concatenated with RIPEMD-160 (SHA-256 (public key))
Checksum=1st 4 bytes of SHA-256 (SHA-256 (Key hash))
Bitcoin address=Base58Encode (Key hash concatenated with Checksum)

It will be appreciated that the hash of an ECDSA public key may be computed using any other suitable method, algorithm or code and is not limited to the above example.

A virtual currency address may be an identifier or account number, which may commonly start with a 1 or a 3 and may contain around 27 to 34 alphanumeric characters. However, an address may also be represented as a QR code, a barcode or any other computer readable data and may not contain any information about the owner. The balance of funds at a particular bitcoin address, for example, may be obtained by looking up the transactions either to or from the address stored in the blockchain. For a transfer of virtual currency to be validated, the owner must provide a private key with the transaction which may be validated by at least one node of the system.

Preferably, a virtual currency is associated with at least one timestamp. A timestamp may be a hash of preselected data which is independent of the blockchain. Multiple hashes of the timestamp may occur when associating the timestamp with at least one block. The preselected data may be at least one of a broadcast, a publication, a forum post, a newspaper, a blog, or any other suitable electronic publication.

A timestamp may provide evidence that the data existed at the time which was timestamped as the hash could only have been generated from the hashed preselected data. For a virtual currency, each timestamp may include the previous timestamp hash as input for its own hash. Therefore, this adds an additional layer of certainty as the previous timestamp provides further evidence that the preceding timestamp hashes existed.

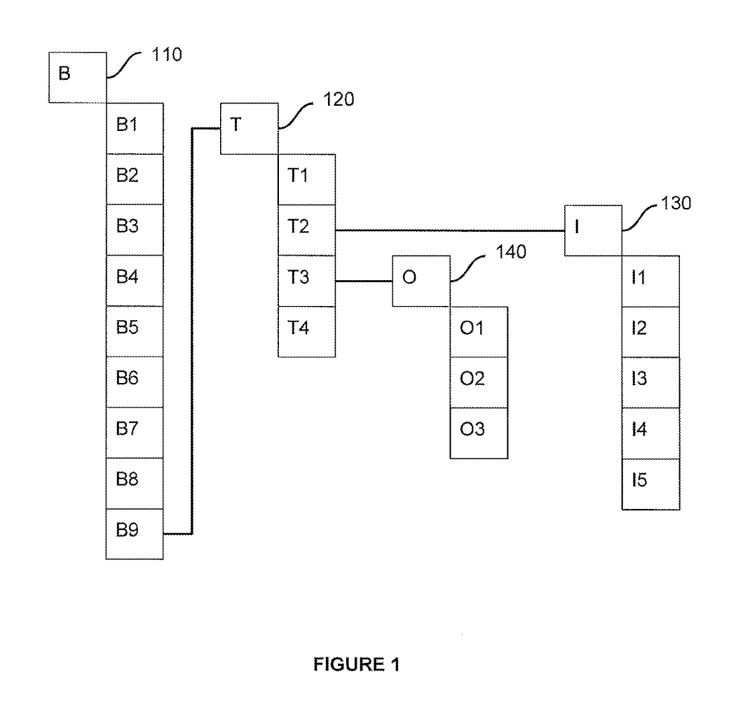

Referring to FIG. 1, there is illustrated a representation of a virtual currency block 100. The block, denoted by B 110, may comprise nine parts denoted as B1 to B9, inclusive, and in this example the virtual currency referred to is a Bitcoin. It will be appreciated that the parse block of the present invention may be adapted to be used with other block chains or other virtual currencies.

Further, B1 represents a “magicID” which may be a 32 bit header of a block in a blockchain. Preferably, B1 may be the first 4 bytes of a block of the blockchain. It will be appreciated that a bit header may also have a different bit length. Preferably, the magicID may have a continuous number or bit, for example 0xD9B4BEF9, although this header may change or be different virtual currencies. In one example, the bit header may return zero bytes for a particular block, which may indicate a missing bit header. If a missing header is returned the system of the present invention may be adapted to fill in or substitute another value for the missing header.

B2 may represent the next bytes in the block, or more particularly the next 4 bytes of the block, and may contain the block length data. A block in a blockchain may be up to around 1MB (one megabyte) in size, which may roughly translate to 7 transactions conducted per second over a 10 minute window. A person of skill in the art will recognise that the block length is not equivalent to the amount of data contained in the block but rather the number of the block in the chain.

B3 is preferably a version number or versionNumber. The version number in the blockchain may be set to a value of 1 (one). This is indicative of the version of the blockchain, and it will be appreciated that the version number may be altered. If the version number is altered the new version number is likely to be higher than the current version number and the system may be configured to adapt to any change in the version number. The version number is generally the same size as that of the magicID and the block length (i.e. 4 bytes).

The data set of the block represented by B4 in the present example is the block header. The block header may contain a 32 byte hash of the previous block added to the blockchain. It will be appreciated that the previous block may be an orphan or a fork in the chain and the system may be adapted to assess more than one block of the blockchain such that each fork of the chain may be simultaneously assessed. The hash of the block is not included in the block as this is a computed value which is not stored on the block. As such, the system may be adapted to compute and store the double hash.

B5 of the block may associated with a MerkleRoot or merkle root hash of the block. The merkle root hash is generally represented by a 32 byte hash and is generally not needed by to parse a block, but may be stored by the system. Storing the merkle root may increase the speed in which the system may retrieve data. This optimisation may occur as the merkle root hash may allow faster or relatively more rapid access to the transaction data of the block without needing to have full access to the entire blockchain transaction history stored.

B6 represents the timestamp of the block. The timestamp generally takes up around 4 bytes of a block. A timestamp may indicate or provide evidence of the time that the block was created. However, the timestamp only corresponds to the time that the block was generated which may be around every 10 minutes in the case of Bitcoin. Therefore, as the overall block size may be limited to a predetermined size, for example around 1 MB, the number of transactions contained within the block may also limited to around 4000 to 4200 transactions, and therefore any transactions which are not prioritised (i.e. the transactions without an accompanying transaction fee) may be substantially older than the block that they are recorded on. Preferably, the system of the present invention may assign a transaction timestamp to each new transaction to establish a hierarchy of non-priority transactions. In at least one embodiment, the timestamp is in ANSI standard C ‘time_t’ format. Other timestamp formats may also be used with the system of the present invention. The system may be configured to optionally timestamp a transaction which is transmitted to the nodes. Timestamping a transaction may assign an order for transactions to take place or provide an additional proof that the transaction was made by an authorised account holder. Timestamping a transaction may also provide an improved account history for at least one blockchain address and may be used to track transactions made across blockchains in a private ledger or track transactions across accounts.

B7 of FIG. 1 may denote the difficulty of the challenge of the block. Similar to other elements of the block, B7 may be around 4 bytes in size. The system of the present invention may ignore the difficulty of the block where the system is not adapted to mine the previous block of the blockchain. B7 may be ignored by the system as the transaction values contained within the block are not required to manipulate or access the transactions stored in the block. Optionally, the system may store the difficulty data so as to map difficulties as a function of time and may be adapted to predict future difficulties as a function of time.

B8 generally denotes the nonce or nonce value of the block and may be around 4 bytes in size. The nonce of the block is a random number value used as part of the mining process and is only required by the system if the system is mining a new block. In a preferred embodiment the nonce value is not needed to interpret the transaction data of the block. However, this data may optionally be stored by the system.

The last component of the block in this example is the transaction count or TransactionCount which is represented by B9. This transaction count is a variable length integer with a size of around 1, 3, 5 or 9 bytes. This part of the block must take into consideration the number of transactions which are on the ledger of the block. See transactions (T) below.

The transactions (T) 120 of the block in this example comprise four main components, T1 to T4, inclusive. The transactions (T) 120 comprise each transaction that which was verified by the miners.

In at least one embodiment, T1 represents a transaction version number. This transaction version number is generally a value of 1 (one) or 2 (two), however transaction number may be another value other than one or two. For example, the bitcoin blockchain contains a number of blocks which contain other values.

T2 may be a number of Inputs (I) which may be a variable length integer. This may be a variable length which designates the number of inputs contained in transactions.

The Inputs (I) 130 of the transactions in at least one example the inputs comprise four parts denoted by I1 to I4, inclusive. I1 may represent a transaction hash which may be about 32 bytes and may be a hash of at least one previous transaction. While the system of the present invention may use a transaction hash in a parse block, the transaction hash is not stored in the block of the blockchain being assessed. Rather, the transaction hash may be calculated by the system as a computed value. In at least one embodiment, the system may optionally store the computed transaction hash.

I2 may represent a transaction index which may be around 4 bytes in size. Similar to I1 in which the transaction hash may refer to at least one previous transaction, the transaction index may denote which output of the previous transaction comprises a particular input. In at least one embodiment, the transaction index may be 0xFFFFFFFF which may be indicative of a value which has no output value. If the system determines that there are no output values the transaction may be indicative of new coins or virtual currency being generated as a ‘reward’ paid to a node by a virtual currency network or indicates the genesis block of the blockchain. If the transaction index is a non-zero it may generally refer to a particular output in at least one previous transaction. In at least one embodiment, the inputs completely use or spend a previous output. Therefore, if a user of the system has a balance of 10 BTC and they wish to send a payment of two BTC a transaction will need to be created which has the input of 10 BTC and then at least two outputs, the two BTC and the remaining eight BTC (2 BTC+8 BTC=10 BTC). Optionally, there may be more than two outputs, for example a third output for a second transaction and a fourth output for a transaction fee. The number of outputs may be limited by the size of the block.

I3 denotes a script length, which may be a variable length integer which may contain the length of the input script.

I4 represents the script data with a length in bytes. This script data contains the raw data which comprises the input script. However, this data is only used by the system if the system is adapted to validate transactions independently of the nodes of the network.

I5 is the sequence number of the input and is generally assigned the value of 0xFFFFFFFF. This field of the input may be ignored by the system or optionally stored as part of a parsed block of the system. Optionally, this value may be manipulated, for example by a predetermined factor or algorithm, such as a cryptographic hash function.

T3 is the output count of the transactions. This output count may be a variable length integer which describes the number of outputs of the transaction.

The output (O) 140 of the transaction may comprise three parts in this embodiment which are O1 to O3, inclusive.

O1 may represent a value which may be around 8 bytes in size. This value may be a 64 bit unsigned integer which may represent the output value which may be measured in a virtual currency portion, such as a Satoshi which is around one hundred millionth of a BTC (0.000000001 BTC). This value may be equal to the total transaction fees on the block plus any mining ‘reward’ that the block has generated.

O2 may denote the script length which may be a variable length integer which may describe the length of the output script.

O3 may be the output script with a length in bytes. While the system may be adapted to validate a transaction, the output script is preferably only used to determine the output address. Generally, an output address will be stored on the block in one of two forms, either a full 65 byte public key or as a 20 byte hash of the public key. The system may then decipher the public key and store the transactions on a computer readable medium. The deciphered public key may be represented in 25 bytes and preferably in an ASCII form, for example a public address in ASCII form may be 574sYjds865wLdoTY547b6zz65dPQwmY4, in this case the public address has 33 bits. The address may then be converted into a binary form, preferably using a binary-to-text encoding function, for use by the system.

T4 may be the transaction lock time and may be a zero value. In at least one embodiment, the transaction lock time may not be required by the system. Optionally, this time may be statefully stored by the system.

It will be appreciated that the block, transaction, transaction inputs and transaction outputs may comprise fewer or more data sets or data values which may be stored by the system. At least one of the above data sets may be statefully stored by the system of the present invention.

It will be appreciated that not all blockchains will comprise blocks with the above data sets or use the preferred hashes. The above block has been used as an example only and is not limiting. For example, a Litecoin™ may use a scrypt based key derivation function instead of a SHA hash function and may use a Base58-encoded hash instead of a SHA hash, for example. Preferably, the system may be adapted to to communicate between blockchains with at least one differing; first set of data, hashing algorithm, block length, block interval, block size, currency type, virtual asset type, coin colour (color), hash length, hash bit size, address size, address location, confirmation time, timestamps, complexity or any other predetermined data set. The system may also be adapted to communicate with blockchains with similar or identical attributes in a broad sense.

In at least one embodiment of the present invention, a user may associate or otherwise link multiple accounts to at least one private key or a hierarchy key. An account may be at least one of the following; a second set of data, a blockchain, a bank account, a stock exchange, a notification system, a personal account, a business account, a real account, a nominal account or any other account suitable for sending and receiving a monetary unit, asset or any other predetermined value. In another embodiment, the system may be adapted to transfer or transact at least one virtual asset or virtual currency between a first address and/or account to a second address and/or account.

While different private key lengths and hashes may be used for different virtual currencies, the system of the present invention may be configured to convert the differing private keys into a uniform key structure. This may be achieved by performing a hash of each private key and associating the private keys with the hierarchy key. The hierarchy key may then be used as a single key to generate transactions across multiple accounts. A different number of hashes may be required to generate a uniform key structure for a given private key such that a user of the system can perform a number of transactions simultaneously. While the system may allow a user to manually perform transactions on a selected blockchain or perform a transaction from or to an account, the system may also be adapted to autonomously generate transactions based on at least one predetermined rule.

The at least predetermined rule must be triggered for the system to generate a transaction for a user.

Optionally, a user may be informed via a message prior to a transaction being generated such that they may veto or alter the transaction. A message may be, for example, a text message, a phone call, an email, an alert, a sound or any other suitable notification.

In another embodiment, the hierarchy key may be used to perform a multisig transaction. For example, if a company has a board of persons which must provide multiple signatures to authorise a transaction, a board leader or trust manager may optionally override the board with a hierarchy key which may sign with all of the board member signatures to perform a transaction. The hierarchy key may be adapted to activate or trigger each part of a multisig private key for a given address. In at least one embodiment, the system may be adapted to split a key into a multisig key with at least one higher order key, such as a hierarchy key. This may reduce the potential for a key to be stolen, replicated or cloned. The hierarchy key may also be used as a single key which may perform transactions on multiple blockchains or accounts.

It will be appreciated that the keys below the hierarchy key may also be used independently of the hierarchy key if desired. For example, a private key associated with a bitcoin account may be used for a transaction without associating with a hierarchy key or a higher level key. Optionally, the system may generate multiple higher order keys. For example, this may allow a company to assign at least one key to an employee based on their seniority or access level and may allow a company to monitor any transactions associated with an employee.

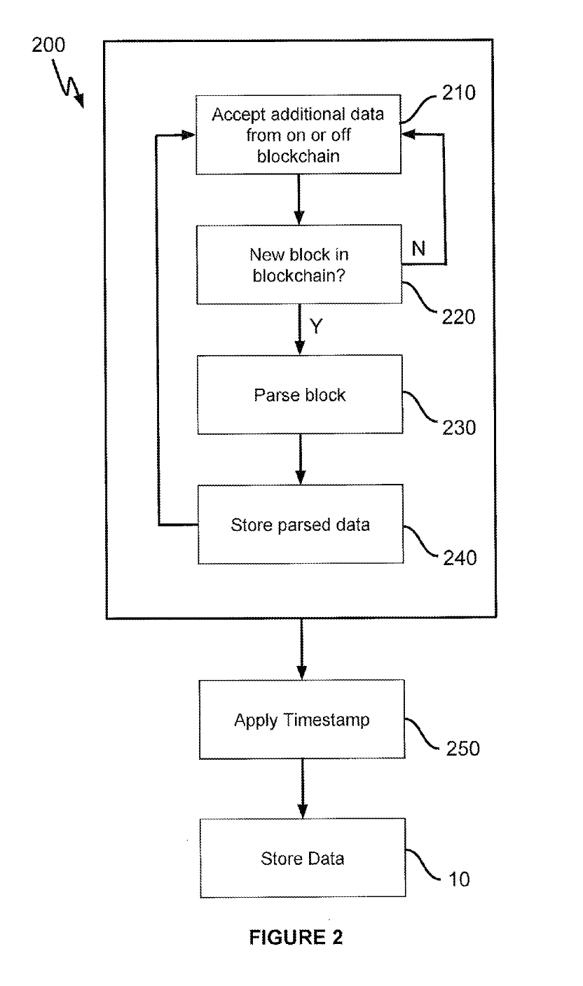

Referring to FIG. 2, the system may be adapted to parse a block on a blockchain 200 and may be adapted to accept additional information 210 from a blockchain or from another data source. If the system accepts any additional data, the data may optionally be statefully stored or associated with at least one block on a blockchain or a potential new block. The additional data may include external publications or inputs such as a virtual currency transaction, a virtual asset transaction, a stock exchange price for a commodity, a currency value, an inflation rate, a GDP value or any other market value which may be quantified. This additional data may be used to trigger rules, which may subsequently trigger at least one action associated with at least one blockchain.

In at least one embodiment, additional data may be received from on blockchain or off blockchain data. Preferably, if additional data is accepted form on or off blockchain data, the data may be timestamped to improve the reliability of the data.

It will be appreciated that the terms “transaction” and “action” may be used interchangeably throughout this specification. An action may include at least one of a blockchain transaction, a financial transaction, a check, a tick, a compliance check, receive data, send data, buy an asset, sell an asset, hold an asset or any other predetermined action which may be associated with at least one blockchain or financial account.

The system may then perform a check whether there is a new block available in the blockchain 220. If there is no new block in the blockchain the system may accept more additional data and may optionally store the data.

If the system determines that there is a new block on the blockchain, the system may process the new block on the blockchain. Preferably, the new block is parsed by the system 230. The parse block may be adapted to split a sequence of characters or values into smaller parts. This may be used for recognising characters or values that occur in a specific order. A rule argument or a rule may be associated with a parse block and may specify how an argument associated with the block is parsed. The rules argument may be a string for simple types of parsing or a block for sophisticated parsing. A parsed block may be stored by the system 240 and may have additional data assigned thereto, such as a personal title for a block a descriptor or other predetermined data.

A parse function may be adapted to accept at least two refinements. For example, the refinements may be /all and /case in which the /all refinement may parse all characters within a strong and the /case refinement may parse a string based on case (i.e. upper and lower case). It will be appreciated that other refinements may alos be used with the system. Preferably, paring of blocks by the system is achieved at a value level which may reduce the time it takes for the system to parse a block.

The present invention may be adapted to determine whether a block has been orphaned or otherwise abandoned by the blockchain. If a block has been orphaned the system may be adapted to ignore or otherwise exclude the orphaned block such that the information contained in the block is not taken to be validated, and therefore transactions recorded on this block are not accepted by the system. Optionally, any orphaned blocks may be stored by the system.

Once a block has been parsed by the system the system may optionally apply a stamp or timestamp to a block 250. A timestamp is preferably associated with at least one public time record such that there is evidence of the validity of the time in which the block was parsed and stamped. The timestamped parsed block may then be stored by the system 10.

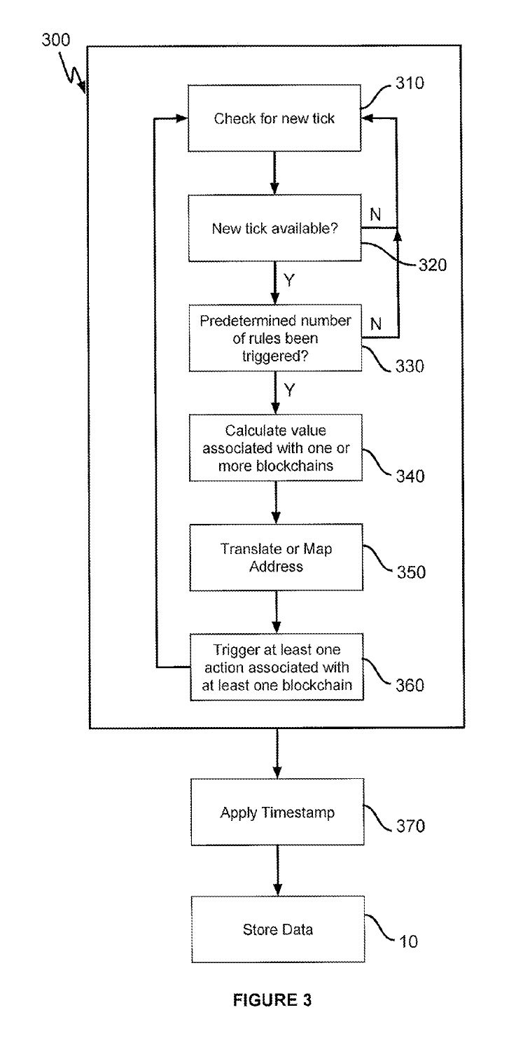

Referring to FIG. 3, there is illustrated a flowchart of an embodiment of a portion of the present invention. At 310 the system may be adapted to detect whether a new tick has been generated by at least one translation function. If a new tick is not available, the system may perform a subsequent check to determine whether a new tick is available 310. The subsequent check may be performed by the system periodically at predetermined intervals, randomly or based on at least one external factor such as if a new parse block is stored or if a new block is added to the blockchain. This check may also be performed after a predetermined number of blocks have been added to a blockchain. In at least one embodiment, a check may be performed either adaptively or dynamically by the system.

A tick may be adapted to simulate background processing for blocks of code and may allow one or more functions to be triggered as a side-effect or condition of having expressions evaluated. Therefore, if a tick is available a rule may be triggered if a predetermined threshold has been exceeded 330. For example, if a tick is available a notification or an alert may be provided to a user if an associated rule is triggered. It will be appreciated that ticks and/or rules may be assigned other more complex predetermined or dynamic attributes if desired.

If a predetermined number of rules have been triggered, at least one value associated with a block or other asset account may be generated or extracted 340. This may allow the system to perform an action on behalf of a user on at least one blockchain or other asset account. Alternatively, the triggered rule may assign new rules for an account or issue responses or messages. For example, a rule to check the commodity value of gold with a predetermined threshold of “buy X ounces of gold if price is less than $1000USD per ounce at blockchain number Y”, after this rule has been triggered a new rule of buy X+Z ounces of gold if price is less than $1000USD per ounce at blockchain number Y+N″, where X, Y, Z and N are all arbitrary numbers. It will be appreciated that any type of new rule may be generated by the system. The system may also adopt machine learning to generate at least one new rule.

After the at least one value has been calculated or extracted, the values may be translated or mapped by the system 350. Preferably, a translation function may be a Base58Check encoding a blockchain address. The Base58Check is a modified Base 58 binary-to-text encoding which differentiates the character fonts such that there may be a significantly reduced possibility that characters look identical to other characters in an account number. Further, there may be a reduced chance of rejection of an account number as the encoding uses alphanumeric characters. Other encoding functions or algorithms may also be used with the present invention, such as Bernstein hash, Fowler-Noll-Vo hash, Jenkins hash, Pearson hash, Zorbist hash Almost linear hash or any other predetermined hash. In at least one embodiment, the other encoding functions or algorithms may be used to extract data from at least one block on a blockchain or virtual asset blockchain.

While it is preferred to use a Base58Check other encoding functions may also be used such as any suitable binary-to-text encoding. A virtual currency address may also be generated by using the Base58Check encoding of the hash of either a pay-to-script (p2sh) hash or a pay-to-pubkey-hash (p2pkh). A p2psh may have a payload which is a RIPEMD160(SHA256(redeemScript the wallet knows how to spend)); version 0x05 which generally comprise addresses beginning with the digit ‘3’. A p2pkh may have payload which is RIPEMD160(SHA256(ECDSA public key the wallet knows the private key for)); version 0x00 which may comprise an addresses beginning with the digit ‘1’. Regardless of the hash used, in each case the resulting hash may be a predetermined byte length, such as 20 bytes for example.

Base58Check encoding may also be used for encoding a private key, such as an ECDSA private key. The private key may be generated in the same manner a virtual currency address is generated, however a 0x80 may be used for the version/application byte, and the resulting payload may be up to 32 bytes instead of 20 bytes. This may be advantageous as a common private key byte length is 32 bytes. In at least one embodiment, if a private key is associated with an uncompressed public key, the encoding will generate a 51-character string which preferably starts with a ‘5’, or more specifically, either ‘5H’, ‘5J’, or ‘5K’.

Once a hash is computed for a set of data, the addresses of the users may be looked up with a HashMap (hash map) or HashSet (hash set). These terms may be used interchangeably throughout the specification. The hash map of the system may be used to process or identify transactions and the addresses associated therewith. Optionally, a hash map may be generated for the transactions on each block. Each input may refer to the transaction hash of the previous output. A hash map may be a sparse array or an associative container which can look up a value, such as an address. Preferably, the hash is large enough to reduce or mathematically eliminate potential collisions. It will be appreciated that there may always be a potential for a collision to occur, however, the possibility for a collision may be greatly reduced. Optionally, a standard template library may be used for the hash map. However, the system preferably utilises a hash template which uses fixed memory allocation which does not delete or remove a stored transaction.

In at least one embodiment, the system may comprise a hash map with raw data such that a block must be parsed before reading block specific data. Optionally, a hash map may be used to access a parsed block stored on another system or in a shared storage.

A transaction hash may be computed by taking the transaction data which contains at least one transaction. This may include the transaction version number and the transaction lock time and any other predetermined data which may have been assigned by the system, such as an external time stamp. This transaction data may then be taken to generate a double hash or block hash, preferably a SHA-256 double hash, and then add the newly generated double hash to a hash map. This may allow the system to process inputs which refer to previous outputs such that a user of the system may lookup transactional history. Optionally, this data may be stored by the system such that an audit or an account history may be generated for at least one address.

A block hash for the system may be computed after a magic ID has been found and after both the block length and block prefix have been read. This block hash may be optionally stored by the system or computed each time. The system may compute the block hash of a block by first computing the hash of the data which may result in a predetermined byte hash length, preferably a 32 byte hash hashed from a SHA256 hash, but other byte sizes may also be generated. A further hash of this computed hash may then be computed to form a double hash known as a “block hash”. If a block refers to a ‘previous’ block hash, this may be the computed value to which the block refers. The hashes to compute or generate the block hash may be generated from a crypto function. An example for calculating a block hash is provided below:

BlockPrefix prefix;

fread(&prefix,sizeof(BlockPrefix),1,fph);

Hash256 blockHash;

computeSHA256(&prefix, sizeof(BlockPrefix),&blockHash);

computeSHA256(&blockHash, sizeof(blockHash),&blockHash);

The above code is only for illustrative purposes and is not intended to be limiting. The block hash computed may then be added to the hash map, such that each block in the blockchain is mapped. The main blockchain may then be built by starting with the last block in the blockchain.

For each block in the blockchain, iterating at least some inputs and at least some outputs may produce the flow of money for a selected transaction. Preferably, all of the inputs and the outputs may be iterated such that every transaction may be mapped by the system. Optionally, the hash maps and parsed blocks may be stored by a computer readable medium such as an SQL (structured query language) database, or any other suitable database or storage base.

This information may allow the system to collate inputs and outputs of all transactions associated with a specific address. This transaction history may be associated with another generated hash map such that the hash map may be indexed by the public key hash address. The entry for each address may contain a list of transactions which may comprise at least one of input and/or output. This may allow the system to generate a balance for a selected address based on the at least one input and output associated with the selected address.

After mapping at least one address or translating a set of data at least one action may be triggered by the system 360. An action may be any predetermined act which may include a transaction, sending a message, sending data, receiving data, buying an asset or selling an asset for example. Other actions may also be achievable by the system. At any time the system may apply a stamp or timestamp to a data set. Preferably, the system timestamps selected data after a rule has been triggered 370. Data generated by the system may be statefully stored 10 and may optionally be associated with at least one other data set on the system.

In at least one embodiment, the system may be adapted to associate a compressed index or transaction number ID based on the location of the array. This may reduce the potential time the system requires to lookup or find an address or transaction.

Preferably, starting with the last block in the blockchain a hash lookup for the previous block is performed. The system may then lookup each previous block hash until it reaches the genesis block where a previous block hash may not be found. If any blocks are skipped in the lookups they may be representative of orphan blocks and may optionally be ignored by the system.

In another embodiment, the system may be able to assign or associate an asset, such as a stock or a commodity to a virtual currency. An asset may be associated with a virtual currency by associating metadata with a blockchain and may be notarised on a blockchain. Storing metadata on a blockchain may be used to generate a meta-blockchain. The metadata may be stored on the blockchain or in a separate database, and may be open for display. Preferably, the virtual currency is associated with an OP_RETURNs to store the metadata, and may have an encoding scheme which allows multiple transfers of different assets to be encoded in a single transaction. An OP_RETURN may immediately mark the script as invalid, and therefore guarantee that the output cannot be spent. In an alternate embodiment, the transaction may be made spendable by anyone such that a cryptographic identity may be more difficult to obtain. If a spendable by anyone transaction is made, the system may be able to optionally record the amount which is assigned to be spendable by anyone.

The system may also be adapted to retrieve and store a contract associated with an asset or metadata libraries or directories for a specified blockchain and display this data to a user of the system. This may allow a transparent transaction to occur as the user of the system may be displayed the inputs and the potential outputs of a transaction prior to confirming a transaction. Optionally, the system may assign a transaction an nLockTime which is a parameter attached to a transaction, which specifies a minimum time in which the transaction cannot be accepted into a block and preferably delays a transaction from being completed. This may optionally place the transaction in an Escrow account or may place the transaction in a mixing service.

Data stored by the system may be transmitted to a publically accessible location or may be accessible to a user of the system. If the data is uploaded to a shared state the system may regulate who may access this data or only display preselected data sets such as the number of users of the system or the number of transactions on the last block on a blockchain, for example.

Stored data may be stored on at least one of a hard drive, a solid state drive, an SQL (structured query language) database, a server, at a storage facility, a cloud or any other computer readable medium. Other suitable storage devices may be used with the system of the present invention. It will be appreciated that the system of the present invention may be adapted for use with blocks of any size.

While the above embodiment may have an example byte size or bit size, these are for illustrative purposes only. It will be appreciated that the byte or bit sizes of the above elements may be any other size sufficient to store block data. In at least one embodiment, the system may be adapted to associate multiple accounts across blockchains with different attributes.

In yet another embodiment, at least one time or timestamp may be assigned to at least one data set of a block being assessed by the system of the present invention. In at least one embodiment the system may be adapted to assign a timestamp to a new block as it is added to a blockchain. In another embodiment, the system may be adapted to assign a timestamp to a block after a predetermined number of blocks have been added to a blockchain. Assigning a timestamp after more than one block has been added improves the certainty that a block will not become an orphan block or a blockchain fork. Preferably, the system may assign a timestamp to a block once there is at least one block either side of the block being assigned a timestamp. For example, if the newest block is assigned a number N, then the block being assigned a timestamp has a block of number (N−1). It will be appreciated that to improve certainty a timestamp may be assigned later than block number (N−1), such as (N−X) where X is any positive integer above 1 (one).

After a timestamp has been assigned to a block, the system may re-evaluate the rules associated to an address, and determine whether any rules have been triggers, are obsolete or contradict a higher order rule. A higher order rule may be a rule which takes priority over a lower order rule, such that the higher order rule may be triggered even if it is contrary to the lower order rule.

A number of predefined rules may be used to trigger at least one predetermined action based on the shared state data. An action may include at least one of the following: a transaction, a wire transfer, send a message, receive a message, sell an asset, buy an asset, hold an asset, transfer an asset, mine a new block, create a new blockchain, or any other predetermined action which may be associated with at least one blockchain.

The present invention may be directed towards a method or system for improving the transparency of virtual currency transactions. Presently, blockchain do not statefully store data of transactions.

In at least one embodiment, at least one rule may be triggered based on at least one of a third set of data, block height, block length, block number, ledger number, stock price, an asset value, commodity value, transaction number, a transfer fee, number of blocks mined, a currency fluctuation, a regulated currency indexation, an inflation rate, a market value of a predetermined asset, or any other predetermined threshold which may be exceeded or otherwise satisfied.

For example, if an address ‘A’ receives a virtual asset, including but not limited to equity, which mas a predetermined threshold, such as an overstocked threshold, the asset may be associated with the address which is represented on the meta-blockchain Counterparty to address A′ (address A which has been translated). In this example, a meta-blockchain may be the last 1 to 10 blocks added to the blockchain, a new block to be added to the blockchain or a combination thereof.

Another example of a rule may be when the blockchain reaches a predetermined block height and if a price of a commodity (such as gold, for example) is greater than a predetermined threshold then transfer $X to address B, where X is a predetermined value.

Yet another example may be when an address C receives a predetermined virtual asset or virtual currency, X virtual currency may be sent to address C, where X represents a predetermined number of virtual currency units.

A further example may be when address D receives $X of a regulated currency (or a token which is associated with a regulated currency), a predetermined stock or share which may be represented on a meta-blockchain Counterparty to address D may be is traded.

Another example may be when a user initiates a transaction a predetermined marker or other attribute assigned to at least a portion of a transaction may terminate or corrupt a transaction if the transaction is not added to a new block before a predetermined time or threshold. A threshold may be at least one of a stock price, a share price, a commodity price, an asset value, a timestamp, a currency valuation or any other predetermined quantifiable factor.

It will be appreciated that other predetermined rules may be used with the system of the present invention. In at least one embodiment, a first rule may be triggered before at least one further rule is triggered such that the at least one further rule interacts with at least one blockchain such that a transaction may be triggered, altered or stopped.

In at least one embodiment, a multisig may be required to perform a transaction or action. Each address of a user may be assigned or associated with at least one independent rule such that when the required independent rules are triggered for the multisig account, a transaction or other predetermined action may be performed.

In another embodiment, a hierarchy key may be an account which may allow a user to perform at least one transaction across one or more blockchains. The account may be adapted to select at least one blockchain or other account to initiate a transaction. The system may optionally allow a user to assign predetermined attributes, such as an nLockTimer, a sell value threshold or any other desired attribute to at least a portion of a transaction or potential future transaction. Optionally, the system may configure the hierarchy key such that a user may configure the hierarchy key to have a vanity address.

In a further embodiment, the system may be adapted to round a transaction such that a transaction fee may include a dust transaction, or a very small denomination of virtual currency as a rounded number. For example, if a user account has 50.00000000456254 currency units, the system may round the account to have 50.000000004 currency unit and retain the rounded down 0.00000000056254 currency units.

It will be appreciated that the system of the present invention may be used with a permissioned distributed ledger or a blockchain. Access to a blockchain does not require a miner or access to a digital currency to access the leger functions.

Although the invention has been described with reference to specific examples, it will be appreciated by those skilled in the art that the invention may be embodied in many other forms, in keeping with the broad principles and the spirit of the invention described herein.

The present invention and the described preferred embodiments specifically include at least one feature that is industrial applicable.

What is claimed is:

1. A system for performing an action on a blockchain, wherein the system comprises;
a first address with an associated first private key for a first blockchain;
a second address with a second key for a second blockchain; and
wherein the first private key and second private key are hashed such that a hierarchy key is generated which is adapted authorise at least one action associated with at least one of the first blockchain and the second blockchain.

2. The system of claim 1, wherein at least one of the first and second keys is a private key.

3. The system of claim 1, wherein at least one rule is associated with one of the first and the second addresses.

4. The system of claim 3, wherein the at least one rule is adapted to trigger at least one action.

5. The system of claim 1, wherein the hierarchy key authorises the trade of a virtual asset.

6. The system of claim 1, wherein at least one address associated with the system is a multisig address.

7. The system of claim 1, wherein the system is adapted to parse a block associated with a blockchain.

8. The system of claim 1, wherein when an action is performed a timestamp is associated with the action.

9. The system of claim 1, wherein the system is adapted to store at least one data set associated with an action.

10. The system of claim 1, more than two blockchains are associated with the system.

11. A system for adapted for use with a virtual asset associated with a blockchain, wherein the system comprises;
parsing at least one block associated with a blockchain and storing the at least one parsed block;
associating at least one user account with the at least one stored parsed block;
assigning a predetermined number of rules to at least one address; and
wherein when at least one of the predetermined number of rules assigned to the at least one address is triggered, an action is performed by the system.

12. The system of claim 11, wherein an action is a transaction.

13. The system of claim 11, wherein a timestamp is associated with at least one action performed.

14. The system of claim 11, wherein a virtual asset is at least one of a virtual currency, a fiat currency, a commodity, a product, a share, a stock, an object, or any other tangible asset.

15. The system of claim 11, wherein at least one data set associated with a parsed block is statefully stored on a computer readable medium.

16. The system of claim 11, wherein a check for a new block on at least one blockchain is performed at a predetermined interval.

17. The system of claim 11, wherein more than one action is triggered simultaneously.

18. The system of claim 11, wherein at least two blockchain addresses are associated with the system, such that more than one action can be performed.

19. The system of claim 11, wherein a hierarchy key is associated with the at least one user account such that a hierarchy key is used to perform actions on more than one address.

20. The system of claim 11, wherein the at least one user of the system can assign at least one rule to at least one account.
